(19) United States
(12) Patent Application Publication
(10) Pub. No.: US 2008/0300985 A1
(43) Pub. Date: Dec. 4, 2008

(54) System and Method for Providing Media Content to Physically Proximate Mobile Devices

(75) Inventors: Scott A. Shamp, Athens, GA (US); Matt Griffin, Buford, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIVERSITY OF GEORGIA RESEARCH FOUNDATION, INC., Athens, GA (US)

(21) Appl. No.: 12/130,290

(22) Filed: May 30, 2008

Related U.S. Application Data
(60) Provisional application No. 60/941,111, filed on May 31, 2007.

(51) Int. Cl. G06Q 30/00; H04N 7/16; H04Q 5/22; H04B 7/26

(52) U.S. Cl. 705/14; 725/32; 340/10.1; 455/41.3

(57) ABSTRACT

In one embodiment, a system and a method pertain to displaying an advertisement, determining media content related to the advertisement to send to a physically proximate mobile device, wirelessly connecting to the physically proximate mobile device, wirelessly transmitting the determined media content to the physically proximate mobile device using a short-range wireless communication protocol.

### CROSS-REFERENCE TO RELATED APPLICATION

This application claims priority to copending U.S. provisional application entitled, “System and Method for Providing Media Content,” having Ser. No. 60/941,111, filed May 31, 2007, which is entirely incorporated herein by reference.

### BACKGROUND

These days, it is common for people carry a mobile device, such as a mobile phone or personal digital assistant (PDA), with them wherever they go. Many such mobile devices comprise significant media capabilities, including audio and video. Given that fact, such mobile devices could be used to provide users with various media content, including advertising content, when the users are in public areas.

### BRIEF DESCRIPTION OF THE DRAWINGS

The disclosed systems and methods can be better understood with reference to the following drawings. The components in the drawings are not necessarily to scale.

FIG. 1 is a schematic view of a first embodiment of a system with which media content can be provided to a physically proximate mobile device.

FIG. 2 is a block diagram of an embodiment of a content distribution system shown in FIG. 1.

FIG. 3 is a flow diagram that illustrates an embodiment of a method for providing media content to a physically proximate mobile device in the system of FIG. 1.

FIG. 4 is a schematic view of a second embodiment of a system with which media content can be provided to a physically proximate mobile device.

FIG. 5 is a block diagram of an embodiment of a computer shown in FIG. 4.

FIG. 6 is a flow diagram that illustrates an embodiment of a method for providing media content to a physically proximate mobile device in the system of FIG. 4.

### DETAILED DESCRIPTION

As described above, mobile devices could be used to provide users with various media content, including advertising content. Described herein are examples of systems and methods for providing such media content. In one embodiment, the physical proximity of a mobile device is detected and, in response, media content is automatically provided to the mobile device. In another embodiment, a mobile device user signals a desire to receive media content and, in response, media content is provided to the mobile device.

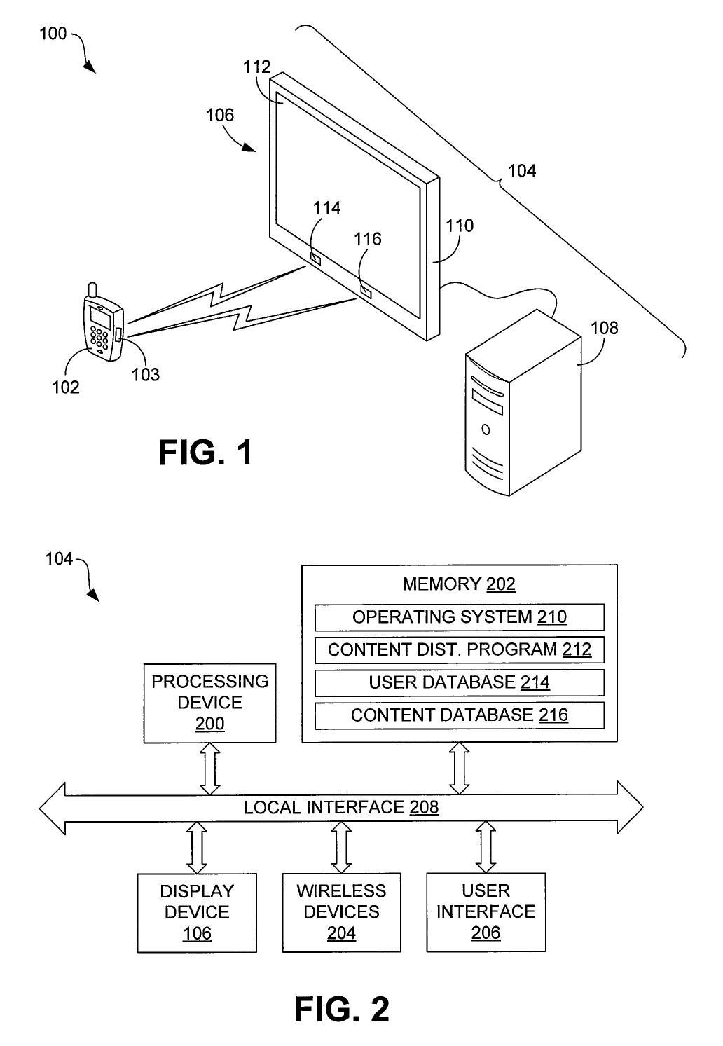

Referring to the drawings, in which like numerals identify corresponding parts throughout the several views, FIG. 1 illustrates a first example system 100 that can be used to provide media content to a physically proximate mobile device. As used herein, the term “physically proximate” is used to convey separation by a relatively small distance within which short-range wireless transmissions can be received. By way of example, a physically proximate mobile device is one within a few meters (m), for instance approximately 0 to 5 m, from a given reference point.

As indicated in FIG. 1, the system 100 generally comprises a mobile device 102 that can communicate with a content distribution system 104. The mobile device 102 comprises substantially any mobile device having graphical audio, and/or video capabilities, as well as the ability to receive wireless data transmissions. By way of example, the mobile device 102 comprises a mobile (e.g., cellular or satellite) telephone or a personal digital assistant (PDA). Irrespective of its particular configuration, the mobile device 102 comprises an identification device 103 that can be used, for example by the content distribution system 104, to detect the physical proximity of the mobile device and identify an owner or user of the mobile device for the purpose of determining what media content, if any, to provide to the mobile device. In some embodiments, the identification device 103 comprises an active or passive radio frequency identification (RFID) tag that stores a user identification code that can be read by an RFID reader.

As its name suggests, the content distribution system 104 is configured to distribute content to mobile devices, such as device 102. Such media content can comprise text, graphics, audio, video, and combinations thereof. In the illustrative embodiment of FIG. 1, the content distribution system 104 includes a display device 106 and a computing device 108 that are placed in communication with each other. As indicated in the figure, the display device 106 can, for instance, comprise a frame 110 that surrounds a display screen 112. Therefore, the display device 106 can have a configuration similar to a flat panel television or monitor. However, unlike a conventional television or monitor, the display device 106 includes wireless communication devices, including an identification device reader 114 and a short-range wireless transmitter 116. As described below, the identification device reader 114 can be used to detect the physical presence of the mobile device 102, while the wireless transmitter 116 can be used to wirelessly send media content to the detected mobile device. In some embodiments, the identification device reader 114 is an RFID tag reader and the short-range wireless transmitter 116 is a short-range radio frequency (RF) transmitter.

FIG. 2 is a block diagram illustrating an example architecture for the content distribution system 104. In the embodiment of FIG. 2, the content distribution system 104 comprises a processing device 200, memory 202, the display device 106, the wireless devices 204 (e.g., identification device reader 114 and short-range wireless transmitter 116), and a user interface device 206, each of which is connected to a local interface 208.

The processing device 200 and memory 202 can, for example, comprise part of the computing device 108. In some embodiments, the processing device 200 comprises a central processing unit (CPU) or a semiconductor-based microprocessor that executes stored commands. The memory 202 includes any one of or a combination of volatile memory elements (e.g., RAM) and nonvolatile memory elements (e.g., hard disk, ROM, etc.).

The user interface 206 comprises the components with which an operator (e.g., system administrator) interacts with the content distribution system 104 and, more particularly, computing device 108. The user interface 206 can comprise, for example, a keyboard, mouse, and a further display, such as a liquid crystal display (LCD).

The memory 202 comprises various programs (i.e., logic) including an operating system 210 and a content distribution program 212. The operating system 210 controls the execution of other programs and provides scheduling, input-output control, file and data management, memory management, and communication control and related services. The content distribution program 212 is configured to control the distribution of media content to physically proximate mobile devices that have been detected by the content distribution system 104. As described below, when a mobile device (e.g., device 102) is detected, the content distribution program 212 determines whether the mobile device user is within a user database 214 also stored in memory 214. If so, the content distribution program 212 determines what media content from a content database 216 to send to the mobile device.

As suggested above, the content distribution system 104 can be used to provide media content to the users of nearby mobile devices. In some embodiments, users pre-register, for example at a website, with the content distribution system 104 so that they will receive such content when physically proximate to the system. In such a case, the users can not only communicate their desire to receive content but further identify the nature of content they would like to receive.

The display device 106 can be placed in a public area, such as within a mall or store, to play video clips that passersby may view. Such video clips can advertise substantially any product or service. For example, the display device 106 can be used to run trailers for movies that are about to be or have recently been released. Notably, however, the video clips need not pertain to advertising. Once identifying the display device 106, registered users may approach the display device to enable receipt of media content. In some embodiments, the media content related to a product or service that is the subject of the displayed video clip can be provided. For example, if, as described above, the display device 106 plays a movie trailer, the movie trailer can be the media content available for download to the mobile device. Once the content distribution system 104 detects the proximity of the user's mobile device, the system can identify the user and determine what media content to provide to the user' mobile device.

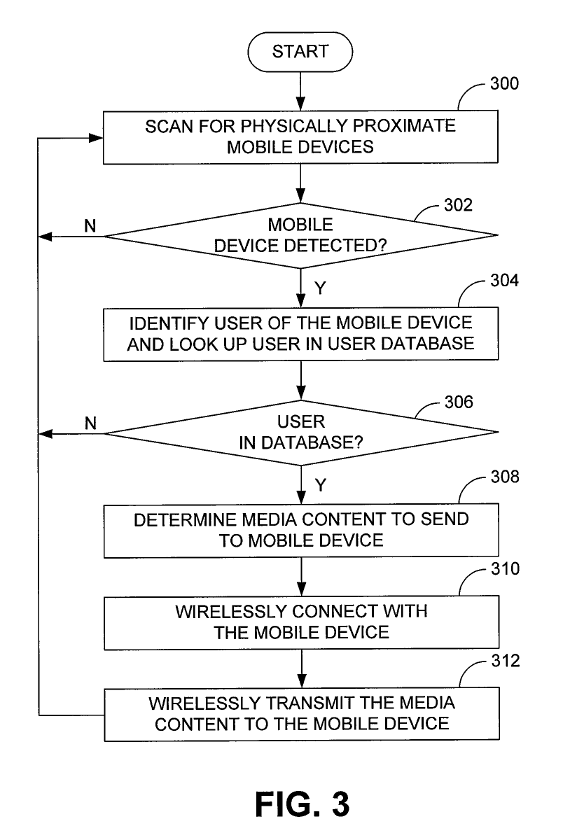

FIG. 3 presents an example of method for providing media content to a physically proximate mobile device consistent with the above description. More particularly, FIG. 3 describes various actions performed by the content distribution system 104 and/or the content distribution program 212 in providing media content to a local mobile device. Beginning with block 300, the content distribution system 104 scans for physically proximate mobile devices. Detection of such mobile devices depends upon the nature of the identification device provided on or in the mobile device and the identification device reader of the content distribution system 104. In embodiments in which the identification device comprises an RFID tag and the identification device reader comprises an RFID tag reader, detection may be limited to detecting mobile devices that are very near the reader, for example within a few meters. Indeed, in some cases, detection may only be possible when the user intentionally positions his or her mobile device immediately adjacent the identification device reader. For example, the user may need to physically “swipe” his or her mobile device across the device reader, which may be explicitly identified to the user for that purpose. In such a case, the user has strong control over whether or not media content will be received by his or her mobile device.

With reference to decision block 302, if no mobile device is detected, flow returns to block 300 at which the content distribution system 104 continues to scan for physically proximate mobile devices. When a mobile device is detected, however, flow continues to block 304 at which the content distribution system 104 identifies the user (e.g., owner) of the mobile device and looks up that user in the user database. By way of example, the content distribution system 104 identifies a user identification code stored in the user identification device (e.g., RFID tag) and uses that code to perform the look up.

Referring next to decision block 306, if the user is not in the user database (or if no user identification code was found in the first place), flow again returns to block 300. If, on the other hand, the user is contained in the user database, flow continues to block 308 at which the content distribution system 104 determines what media content to send to the user's mobile device from information associated with that user contained within the database. As mentioned above, the media content that will be provided may depend upon user preferences that were expressed by the user during a registration process. Such a process may be used to identify the types of media to provide (e.g., text, graphics, audio, video), the nature of the subject matter (e.g., child friendly or more mature content), limits as to the amount of data that will be provided, and so forth.

Once the determination as to what media content to send has been made, the content distribution system 104 wirelessly connects with the mobile device, as indicated in block 310. In some embodiments, such connection is facilitated by information, such as a device address, regarding the user's mobile device that is stored in the user database. Alternatively, such information can be received along with the user identification code when the user's identification device is read. Regardless, the system 100 can then wirelessly transmits the media content to the mobile device, as indicated in block 312. Because the mobile device is physically proximate to the content distribution system 104, short-range wireless communication protocols can be used to transmit the media content. For example, the media content can be transmitted using an IEEE 802.11 protocol (“Wi-Fi”), Bluetooth, or an IEEE 802.15 protocol (“Zigbee”). Therefore, a telephony or Internet functionality of the mobile device need not be used to receive the media content.

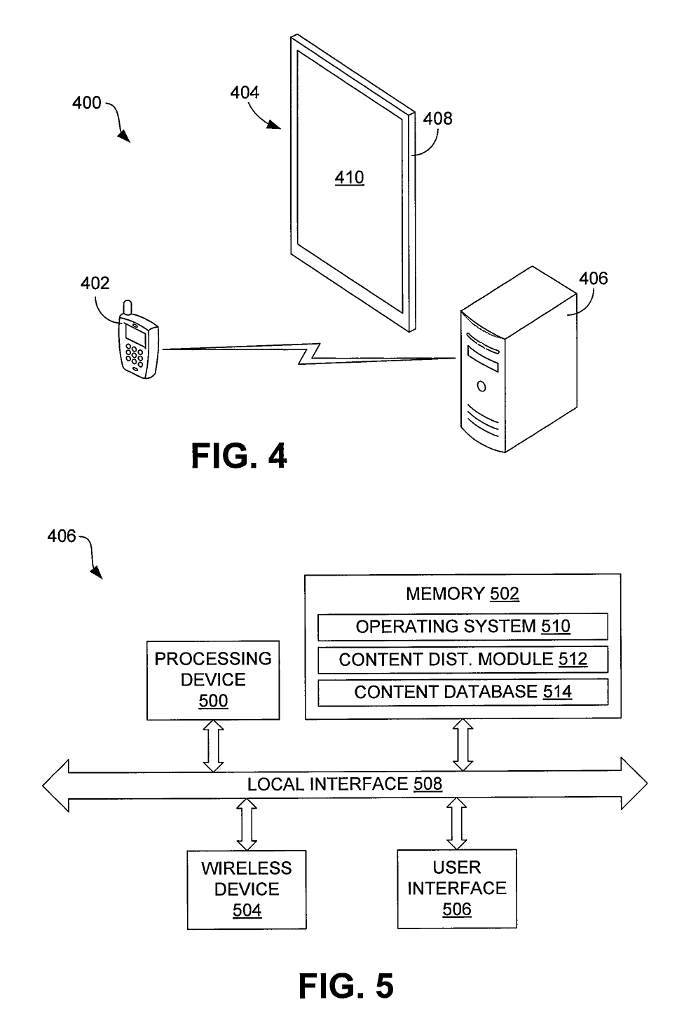

FIG. 4 illustrates a second example system 400 that can be used to provide media content to a physically proximate mobile device. Like the system 100, the system 400 comprises a mobile device 402, such as a mobile telephone or a PDA, and a computing device 406. Unlike the system 100, however, the system 400 comprises no display device. Instead, the system 400 comprises a static advertisement 404, which also may be placed in a public place. In the embodiment of FIG. 4, the advertisement 404 comprises a poster 410 that is placed within a frame 408. The advertisement 404 can advertise substantially any produce or service. By way of example, the poster advertises a movie that is about to be or has recently been released. Regardless of the nature of the advertisement 404, the computing device 406 is positioned near the advertisement to facilitate short-range wireless communications with the mobile devices, such as mobile device 402, of observers of the advertisement 404.

In some embodiments, the advertisement 404 includes instructions explaining to passersby how to download information regarding the advertised goods or services to their mobile devices. For example, the advertisement 404 can specify an address of the computing device 406 to which content requests can be sent from the user's mobile device.

FIG. 5 is a block diagram illustrating an example architecture for the computing device 406. In the embodiment of FIG. 5, the computing device comprises a processing device 500, memory 502, a wireless device 504, and a user interface device 506, each of which is connected to a local interface 508.

The processing device 500, memory 502, and user interface 506 can, at least in some embodiments, have the same or similar configurations and/or functions to the like-named components described in relation to FIG. 2. The wireless device 504 comprises a device with which the computing device 406 can wirelessly communicate with physically proximate mobile devices using a short-range wireless protocol, such as an IEEE 802.11 protocol, Bluetooth, or an IEEE 802.15 protocol (“Zigbee”). Therefore, the wireless device 504 can, for example, comprise a short-range RF transceiver.

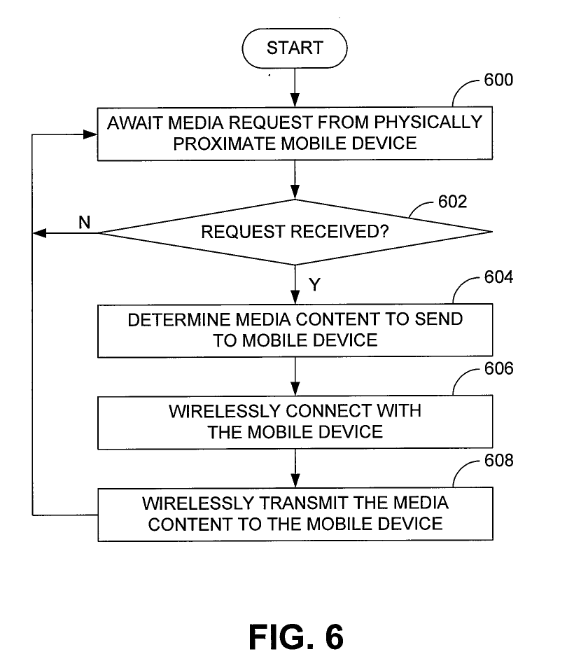

Like the content distribution system 104 of FIG. 2, the memory 502 comprises various programs (i.e., logic), including an operating system 510 and a content distribution program 512. The content distribution program 512 is similar to the content distribution program 212 in that it is configured to send media content from a content database 514 to physically proximate mobile devices. The content distribution program 512, however, does not detect mobile devices, determine a user identity, and determine what media content to send based upon the user's identity. Instead, the content distribution program 512 awaits requests for media content from substantially any user and then provides the same content to each requester. FIG. 6 illustrates an example of such a process.

As with the display device 106 of the content distribution system 104 of FIG. 1, the advertisement 404 can be placed in a public area, such as within a mall or store for passersby to view. When such a passerby wishes to receive media content on his or her mobile phone relevant to the advertisement 404, that passerby, or user, can send a request to the computing device 406 (which may or may not be visible) associated with the advertisement. Therefore, as indicated in block 600 of FIG. 6, the computing device 408 can await a content request from a physically proximate mobile device. The request can be transmitted to the computing device 408, which will be physically near the advertisement 404 when the user views it, with a short-range wireless protocol. By way of example, the user can send a Bluetooth message to the computing device 406 that requests media content relevant to the advertisement 404. If, for instance, the advertisement 404 comprises a movie poster, the media content could be text and graphics that identify show times in local theaters or a video clip of a trailer for the movie.

With reference next to decision block 602 of FIG. 6, if no request is received, flow returns to block 600 at which the computing device continues to wait for a request. If a request is received, however, flow continues to block 604 at which the computing device 408 determines what media content to send. In some cases, for example in the case of a static poster advertisement, the media content will always be the same. In other cases, however, the media content that is sent may vary. For instance, if the advertisements change, for example in a scrolling advertisement display in which posters are intermittently replaced with other posters, the media content may be selected so that content relevant to the poster on display at the time of request is sent.

Once the media content to send has been determined, flow continues to block 606 at which a wireless connection is made with the mobile device, and block 608 at which the media content is wirelessly transmitted to the mobile device, again using a short-range wireless protocol.

Various programs (logic) have been described herein. It is noted that those programs can be stored on any computer-readable medium for use by or in connection with any computer-related system or method. In the context of this document, a “computer-readable medium” is an electronic, magnetic, optical, or other physical device or means that contains or stores a computer program for use by or in connection with a computer-related system or method. Those programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The following are claimed:

1. A method for providing media content to a mobile device, the method comprising:
displaying an advertisement;
determining media content related to the advertisement to send to a physically proximate mobile device;
wirelessly connecting to the physically proximate mobile device;
wirelessly transmitting the determined media content to the physically proximate mobile device using a short-range wireless communication protocol.

2. The method of claim 1, wherein wirelessly transmitting comprises wirelessly transmitting using an IEEE 802.11 protocol.

3. The method of claim 1, wherein wirelessly transmitting comprises wirelessly transmitting using a Bluetooth protocol.

4. The method of claim 1, wherein wirelessly transmitting comprises wirelessly transmitting using an IEEE 802.15 protocol.

5. The method of claim 1, wherein wirelessly transmitting comprises wirelessly transmitting text and graphics to the mobile device.

6. The method of claim 1, wherein wirelessly transmitting comprises wirelessly transmitting audio and video to the mobile device.

7. The method of claim 1, wherein displaying an advertisement comprises displaying a video advertisement on a display device.

8. The method of claim 7, further comprising detecting the physical proximity of the mobile device before determining the media content to send.

9. The method of claim 8, wherein detecting the physical proximity comprises detecting the physical proximity using a device integrated with the display device.

10. The method of claim 8, wherein detecting the physical proximity comprises detecting the physical proximity of a radio frequency identification (RFID) tag of the mobile device using an RFID tag reader.

11. The method of claim 10, further comprising reading a user identification code stored in the RFID tag and wherein determining the media content to send comprises determining media content to send based upon the user identification code.

12. The method of claim 1, wherein displaying an advertisement comprises displaying a static advertisement.

13. The method of claim 12, further comprising receiving a request from the mobile device for media content associated with the displayed advertisement.

14. A system comprising:
a processing device;
memory that stores a content distribution program, the program being configured to determine media content related to a displayed advertisement to send to a physically proximate mobile device, to wirelessly connect to the physically proximate mobile device, and to wirelessly transmit the determined media content to the physically proximate mobile device using a short-range wireless communication protocol; and
a short-range wireless device configured to wirelessly transmit data over short distances.

15. The system of claim 14, wherein the short-range wireless device is configured to wirelessly transmit data using an IEEE 802.11 protocol, a Bluetooth protocol, or an IEEE 802.15 protocol.

16. The system of claim 14, further comprising a display device that displays a video advertisement.

17. The system of claim 16, wherein the display device comprises an identification device reader configured to detect physically proximate mobile devices.

18. The system of claim 17, wherein the identification device reader comprises a radio frequency identification (RFID) tag reader configured to read RFID tags provided on the mobile devices.

19. The system of claim 18, wherein the RFID tag reader is configured to read a user identification code stored in the RFID tag.

20. The system of claim 19, wherein the content distribution program is configured to determine the media content to send relative to the user identification code.

21. The system of claim 14, wherein the content distribution program is configured to receive from physically proximate mobile devices requests for media content associated with the displayed advertisement.

22. A computer-readable medium that stores a content distribution program, the program comprising:
logic configured to determine media content related to a displayed advertisement to send to a physically proximate mobile device;
logic configured to wirelessly connect to the physically proximate mobile device; and
logic configured to wirelessly transmit the determined media content to the physically proximate mobile device using a short-range wireless communication protocol.

23. The computer-readable medium of claim 22, wherein the logic configured to wirelessly transmit comprises logic configured to wirelessly transmit data using an IEEE 802.11 protocol, a Bluetooth protocol, or an IEEE 802.15 protocol.

24. The computer-readable medium of claim 22, wherein the logic configured to determine media content to send comprises logic configured to determine media content to send relative to a user identification code that has been read from an identification device of the mobile device.

25. The computer-readable medium of claim 22, further comprising logic configured to receive from physically proximate mobile devices requests for media content associated with the displayed advertisement.
